(19) United States
(12) Patent Application Publication
(10) Pub. No.: US 2026/0199717 A1
(43) Pub. Date: Jul. 16, 2026

(54) FALL ARREST DEVICE FOR RECOVERING ROPE AT REDUCED SPEED

(71) Applicant: YOKE INDUSTRIAL CORP., Taichung City (TW)

(72) Inventors: WEI-CHIEH HUNG, Taichung City (TW); CHIA-HSIEN WANG, Taichung City (TW); TZU-LUN WENG, Taichung City (TW); JIA-MIN LIN, Taichung City (TW)

(73) Assignee: YOKE INDUSTRIAL CORP., Taichung City (TW)

(21) Appl. No.: 19/015,652

(22) Filed: Jan. 10, 2025

(51) Int. Cl. A62B 35/00

(52) U.S. Cl. CPC A62B 35/0093

(57) ABSTRACT

A fall arrest device with a ring that allows for decelerative recovery is provided. A main shaft is fixed in a casing. A rotating drum is fitted onto the main shaft. A spiral spring is engaged between the main shaft and the rotating drum. A rope extending out of the casing is wound around the rotating drum. A braking assembly is engaged with a side of the rotating drum. A braking device for engaging with the braking assembly is fixed within the casing. A deceleration assembly is disposed in the rotating drum. A damper holder is fixed to the main shaft and a rotary damper is fixed to the damper holder and spaced apart from the main shaft. A driving gear that meshes with the rotary damper is fixed to an inner wall portion of the rotating drum and is coaxial with the rotating drum.

### BACKGROUND OF THE INVENTION

### Technical Field

The present invention relates generally to a safety apparatus for working at height, and more particularly to a fall arrest device for recovering a rope at a reduced speed.

### Description of Related Art

When a conventional fall arrest device is used, a casing is secured at a fixed position, and an end of a rope passing through the casing is engaged with a wearable harness on a user. When the user wearing the wearable harness falls from height, a rotating drum in the fall arrest device rotates quickly by pulling the rope. At that time, a braking assembly within the rotating drum is engaged with a deceleration device fixed within the casing, preventing the rotating drum from continuing to rotate and releasing the rope. In this way, the user could be prevented from falling further, achieving the safety effect of fall prevention.

The conventional fall arrest device mentioned above is equipped with a spiral spring in the casing, which is used to return the rotating drum to an original position after rotation. Hence, when the rope of the fall arrest device is released from the casing and a force is not continuously applied to the rope, the rotating drum would rotate reversely to return to the original position. During the process of the rotating drum returning to the original position, the released rope rewound into the casing. Although the rewindable design of the rope allows the fall arrest device to recover the rope after the rope is released, no deceleration means is provided during the process of the rotating drum rewinding the rope. When the rope transitions from a pulled state to a free state, the rope being rapidly rewound by the rotating drum may swing and collide with the user due to a high rewinding speed, resulting in potential hazards.

### BRIEF SUMMARY OF THE INVENTION

In view of the above, the primary objective of the present invention is to provide a fall arrest device which is equipped with a device to decelerate a rotating drum, wherein the device reduces a speed at which the rotating drum automatically rewinds a rope, preventing the rope from swinging and posing a danger to surrounding objectives and human body due to an excessive rotational speed during a rewinding process.

The present invention provides a fall arrest device for recovering a rope at a reduced speed, including a casing, a main body, and a deceleration assembly. A mounting space is provided in the casing, and a side of the casing has a rope exit; the rope exit communicates with the mounting space. The main body includes a main shaft, a rotating drum, a spiral spring, a rope, a braking assembly, and a braking device. The main shaft is fixed in the mounting space. The rotating drum is rotatably fitted around the main shaft. A side of the rotating drum has a mounting portion. A spiral spring cavity and a deceleration assembly cavity are provided in the rotating drum. A portion of an inner side of the rotating drum that is adjacent to the deceleration assembly cavity forms an inner wall portion. The spiral spring is disposed in the spiral spring cavity and has two ends. The two ends of the spiral spring are engaged with the main shaft and the rotating drum, respectively. An end of the rope is engaged with the rotating drum and is wound around the rotating drum to have a plurality of turns; another end of the rope extends out of the rope exit. The braking assembly is engaged with the mounting portion. The braking device is fixed in the mounting space and is configured to engage with the braking assembly. A deceleration assembly is disposed in the deceleration assembly cavity and includes a damper holder, at least one rotary damper, and a driving gear. The damper holder is fixed to the main shaft. The at least one rotary damper is fixed to the damper holder and is spaced apart from the main shaft. The driving gear is fixed to the inner wall portion of the rotating drum and is coaxial with the rotating drum. The driving gear is meshed with the at least one rotary damper.

With the aforementioned design, when a user connects the rope to wearable harness on the user and pulls the rope outward from the rope exit by hand or through body movement, the spiral spring will apply the restoring force to the rotating drum for reverse rotation. At this point, if a connection between the rope and the wearable harness is suddenly broken or the user suddenly loosens the rope, the spiral spring will drive the rotating drum to rotate reversely and rapidly rewind the rope. However, due to the damping effect of the at least one rotary damper of the deceleration assembly, the speed at which the spiral spring drives the rotating drum to recover the rope is slowed down. In this way, the rope could be prevented from moving too quickly during a recovering process, reducing the risk of the rope swinging and posing a danger to surrounding objectives and human body. Therefore, the fall arrest device for recovering the rope at the reduced speed is safer to use.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the fall arrest device according to an embodiment of the present invention;

FIG. 2 is an exploded view of the fall arrest device according to the embodiment of the present invention;

FIG. 3 is an exploded view of the main body and the deceleration assembly in FIG. 2;

FIG. 4 is an exploded view of the braking device and the main shaft in FIG. 3;

FIG. 5 is an exploded view of the deceleration assembly and the main shaft in FIG. 3;

FIG. 6 is a right-side view of the fall arrest device according to the embodiment of the present invention;

FIG. 7 is a sectional view along the 7 -7 line in FIG. 6;

FIG. 8 is a front view of the fall arrest device according to the embodiment of the present invention;

FIG. 9 is a sectional view along the 9 -9 line in FIG. 8; and

FIG. 10 is a sectional view along the 10 -10 line in FIG. 8.

### DETAILED DESCRIPTION OF THE INVENTION

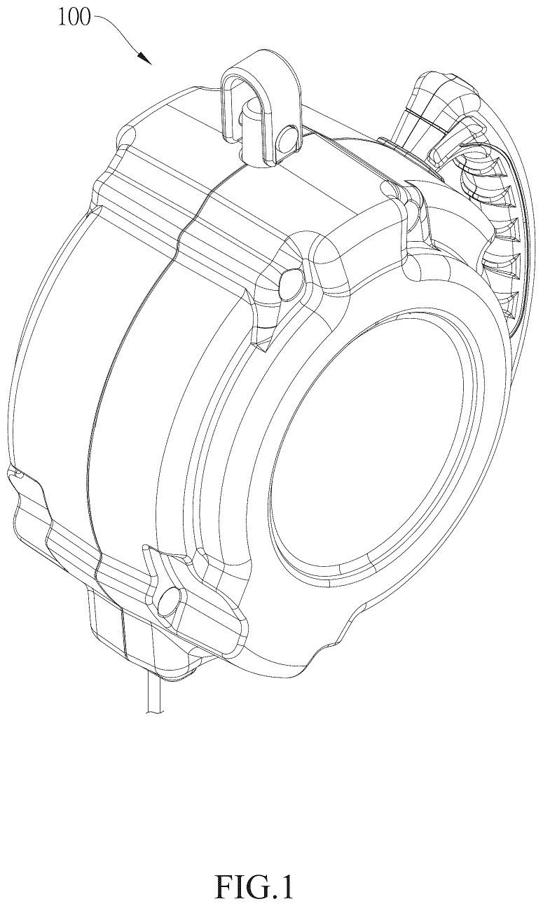

A fall arrest device 100 for recovering a rope at a reduced speed according to an embodiment of the present invention is illustrated in FIG. 1 to FIG. 5 and includes a casing 10, a main body 20 and a deceleration assembly 30. The main body 20 and the deceleration assembly 30 are mounted in the casing 10. According to an arrangement of the casing 10 in an operational state, two opposite sides of the fall arrest device 100 for recovering the rope at the reduced speed in a top-bottom direction are defined as a top side and a bottom side, respectively. Based on this directional definition, the structure of the fall arrest device 100 for recovering the rope at the reduced speed is described as follows.

The casing 10 includes two half casing 10A and has a mounting space S inside. The two half casing10A are engaged with each other by screwing, so that the two half casing 10A are detachable relative to each other. In other embodiments, the two half casings 10A could be engaged by hooking or tenoning. Each of the half casing 10A has a side wall 12 and a peripheral wall 14 connected to the side wall 12. The two side walls 12 of the two half casings 10A face each other. A peripheral edge of a top side of the peripheral wall 14 of each of the half casings 10A forms a ring recess 161. The two ring recesses 161 of the two half casings 10A are semi-circular and are joined to form a ring hole 16. The ring hole 16 communicates with the mounting space S. A peripheral edge of a bottom side of the peripheral wall 14 of each of the half casings 10A forms a rope recess 181. The two rope recesses 181 of the two half casings 10A are U-shaped and joined to form a rope exit 18. The rope exit 18 communicates with the mounting space S. A guiding ring 182 is fixed on a peripheral edge of the rope exit 18.

The main body 20 includes a frame 22, a main shaft 24, a rotating drum 26, a spiral spring 28, a rope 21, a braking assembly 23 and a braking device 25. The frame 22 is fitted into the mounting space S of the casing 10 and includes a ring seat 221, two side plates 222 and a connecting rod 223. The ring seat 221 is disposed at a top of the mounting space S, where a ring 224 is engaged with the ring seat 221. The ring 224 passes through the ring hole 16 of the casing 10. The two side plates 222 are respectively placed on two inner sides of the two side walls 12. The ring seat 221 is connected to two top ends of the two side plates 222. Two ends of the connecting rod 223 are connected to two bottom ends of the two side plates 222. A center of each side plate 222 has a side plate perforation 225. Each of the side plate perforations 225 is a non-circular perforation.

Two ends of the main shaft 24 are fitted into the two side plate perforations 225 of the two side plates 222, so that the main shaft 24 is fixed within the mounting space S of the casing 10 and could not be rotated relative to the casing 10. The main shaft 24 has an axial direction L, which is perpendicular to the top-bottom direction. The main shaft 24 has a holder fixing portion 241 and a socket fixing portion 242 respectively on two sides along the axial direction L. A peripheral surface of the holder fixing portion 241 is a non-circular surface, and a peripheral surface of the socket fixing portion 242 is a non-circular surface. In the current embodiment, a portion between the two ends of the main shaft 24, aside from the holder fixing portion 241 and the socket fixing portion 242, is a cylindrical rod. In other embodiments, only a portion of the main shaft 24 between the two ends of the main shaft 24 and for coupling with a rotatable object is a cylindrical rod; for example, the portion of the main shaft 24 that is coupled with the rotating drum 26 is a cylindrical rod.

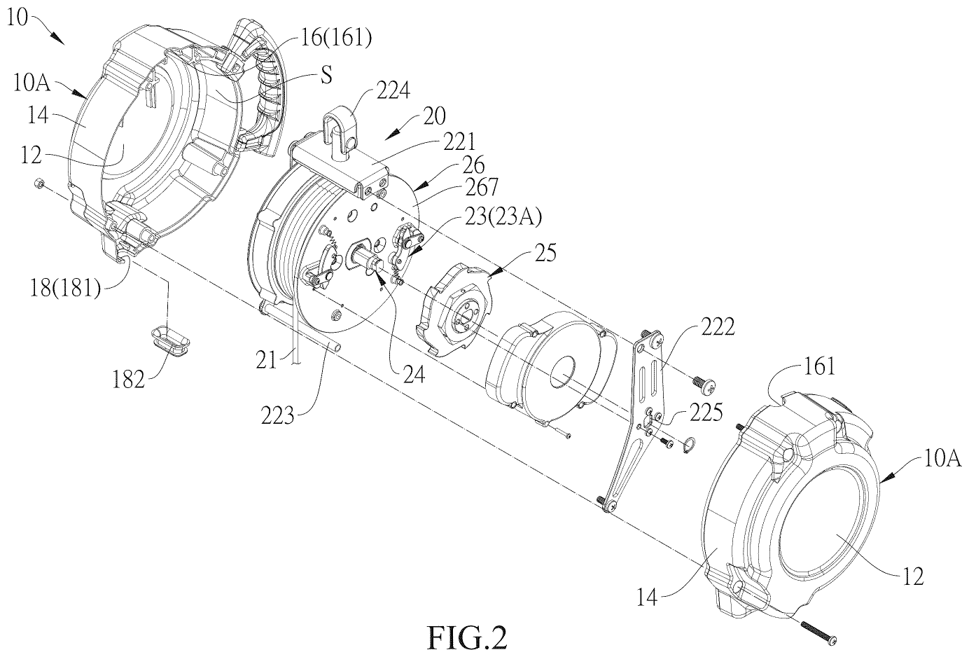

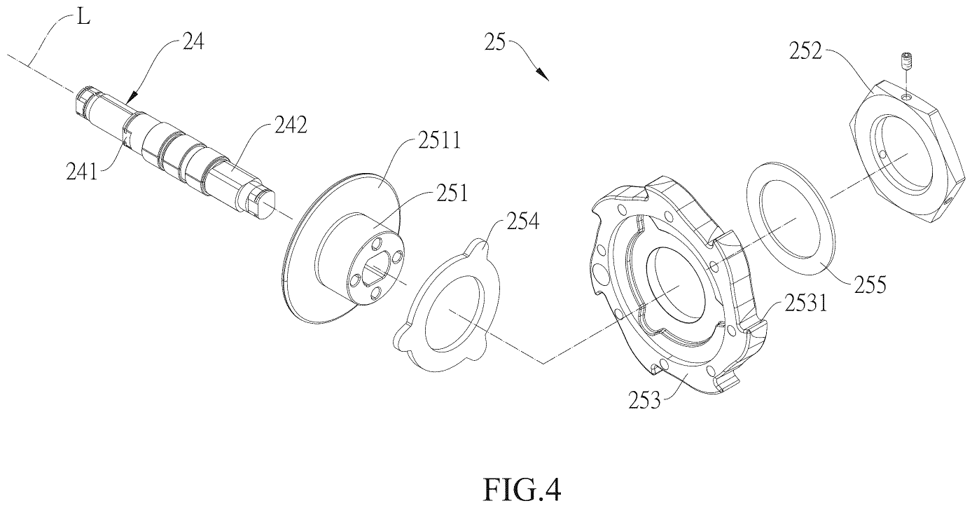

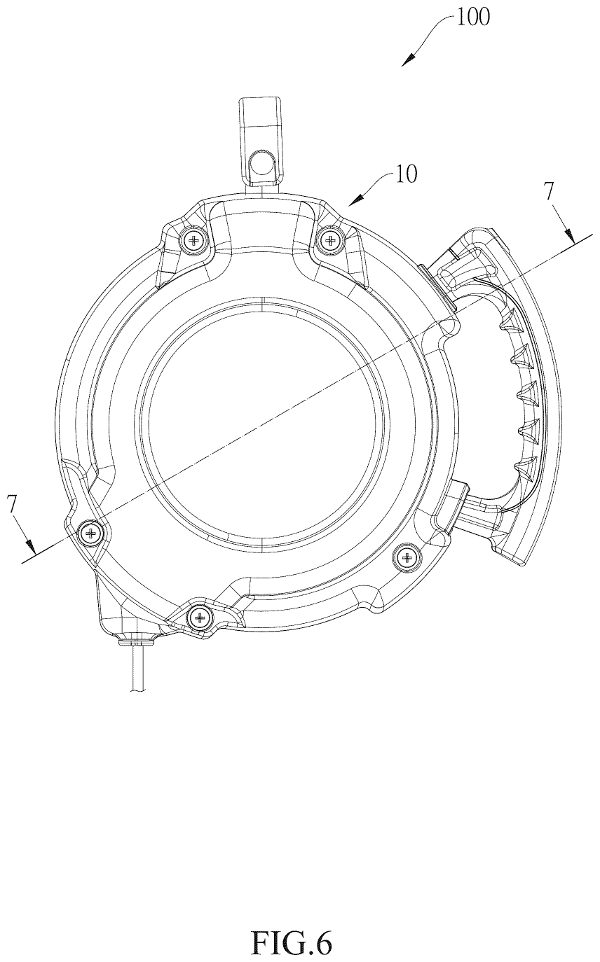

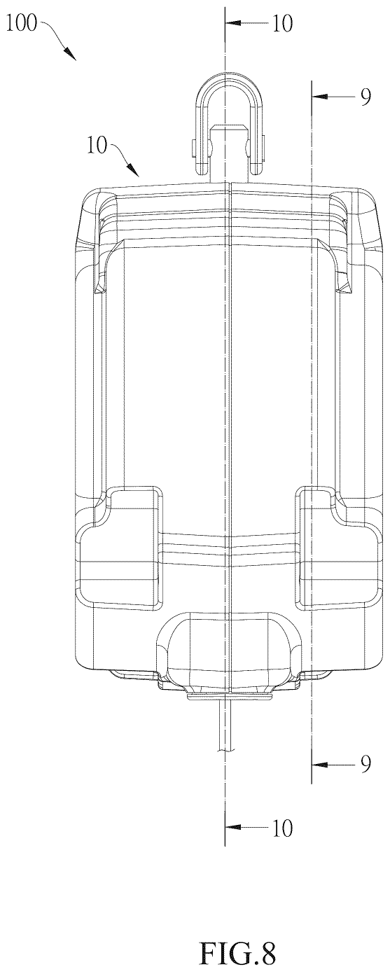

Referring to FIG. 2, FIG. 4 and FIG. 6 to FIG. 9, a center of the rotating drum 26 has an axial hole 261. The axial hole 261 is rotatably fitted onto the main shaft 24, so that the rotating drum 26 is rotatably fitted around the main shaft 24. A rope groove 262 is provided around the rotating drum 26. A spiral spring cavity 263 and a deceleration assembly cavity 264 are provided in the rotating drum 26 along the axial direction L. In the current embodiment, the axial hole 261 directly communicates with the deceleration assembly cavity 264, and a portion of an inner side of the rotating drum 26 adjacent to the deceleration assembly cavity 264 forms an inner wall portion 265. A surface of the inner wall portion 265 is perpendicular to the axial direction L of the main shaft 24. One side of the spiral spring cavity 263 communicates with the deceleration assembly cavity 264, and a diameter of the spiral spring cavity 263 is greater than a diameter of the deceleration assembly cavity 264. A flange portion 266 is formed around a perimeter between the spiral spring cavity 263 and the deceleration assembly cavity 264. A side of the rotating drum 26 corresponding to the axial direction L has a mounting portion 267, while the other side of the rotating drum 26 corresponding to the axial direction L has a cover plate 268. The cover plate 268 covers the other side of the spiral spring cavity 263 and has a cover plate perforation 2681 on a center of the cover plate 268, through which the main shaft 24 passes.

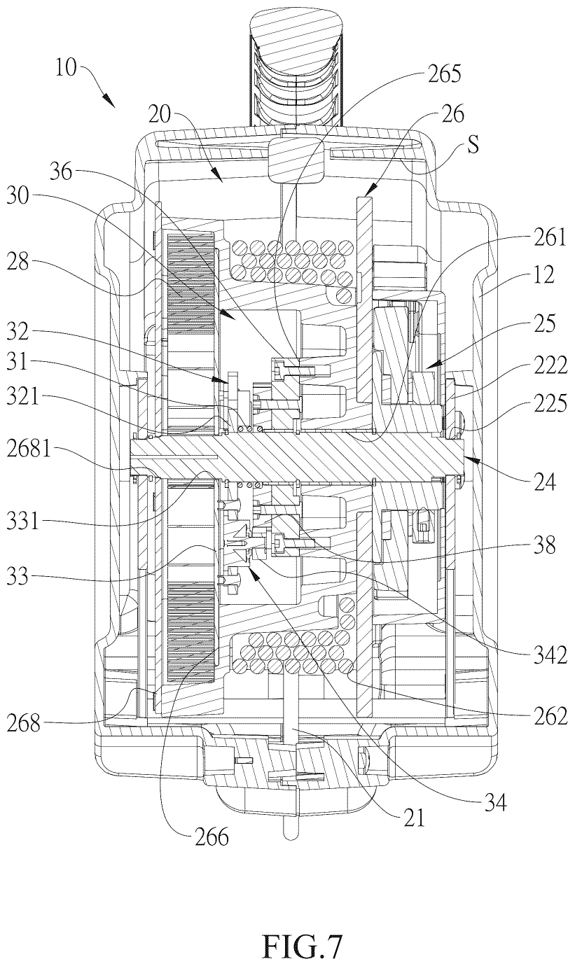

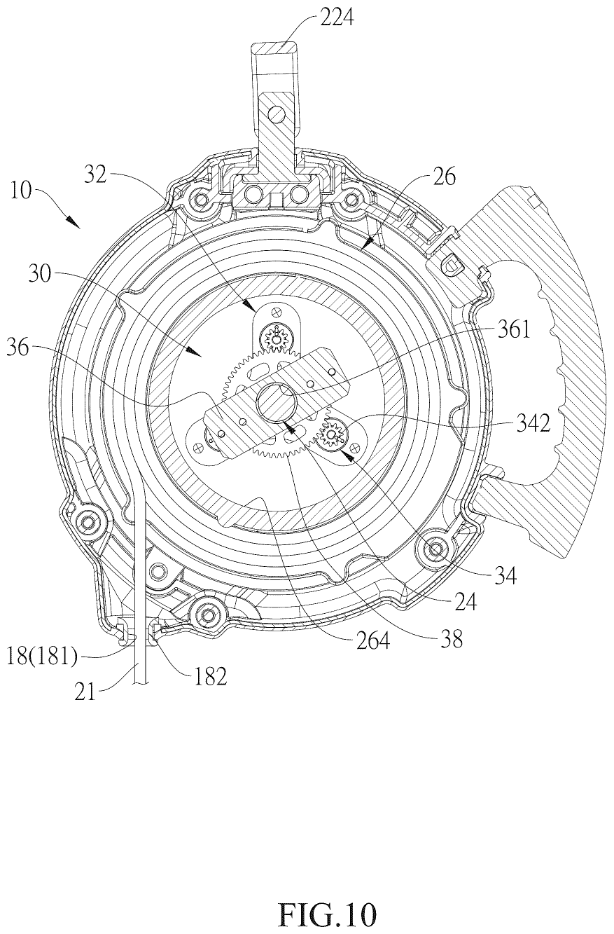

The spiral spring 28 is disposed in the spiral spring cavity 263, and the spiral spring 28 has two ends. One of the two end of the spiral spring 28 is engaged with the main shaft 24, and the other end of the spiral spring 28 is engaged with the rotating drum 26. Therefore, when the rotating drum 26 rotates relative to the main shaft 24 to deform the spiral spring 28, the spiral spring 28 will provide a restoring force to the rotating drum 26 for returning the rotating drum 26 to an original position. The rope 21 has two ends. An end of the two ends of the rope 21 is engaged with the rotating drum 26. The rope 21 is housed in the rope groove 262 and is wound around the rotating drum 26 to have a plurality of turns. Another end of the two ends of the rope 21 extends out of the rope exit 18 of the casing 10 from an inner side of the guiding ring 182. As shown in FIG. 7 and FIG. 10, when the rope 21 is pulled outward from the rope exit 18 by an external force, the rope 21 drives the rotating drum 26 to rotate around the main shaft 24, wherein a rotation direction of the rotating drum 26 at that time is defined as a forward direction. On the contrast, when the external force pulling the rope 21 outwards is removed, the spiral spring 28 provides the restoring force for the rotating drum 26 to rotate and restore to the original position, wherein at that time, the rotating drum 26 rotates reversely and recovers the rope 21, which has been released outwards, into casing 10, re-winding the rope 21 around the rotating drum 26.

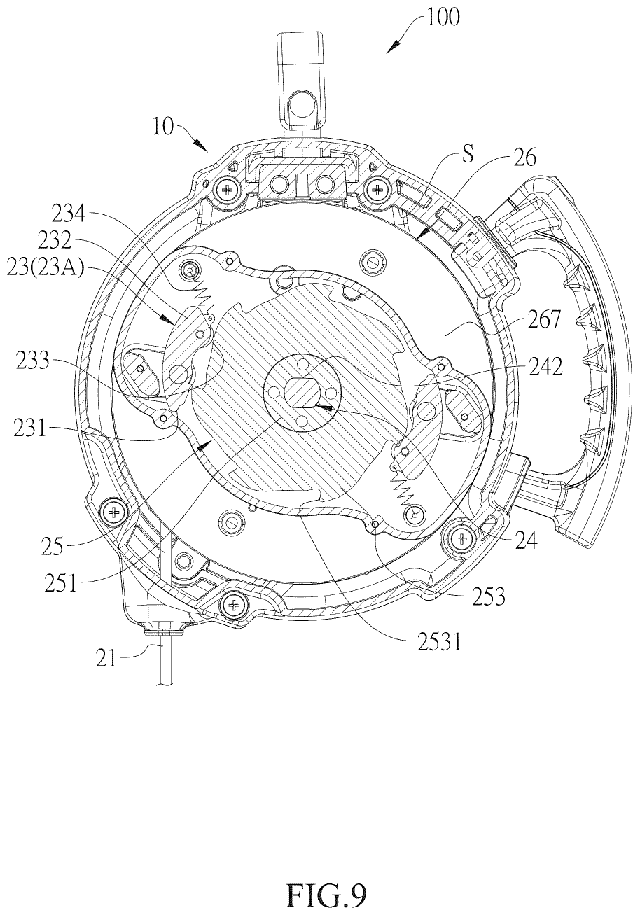

Referring to FIG. 2, FIG. 4 and FIG. 9, the braking assembly 23 includes two pawls 23A, which are arranged around the main shaft 24. A center of each of the pawls 23A is rotatably connected around the mounting portion 267. Each pawl 23A has an end that forms a pawl nose portion 231, while the other end of each of the pawls 23A forms a pawl body portion 232. Each of the pawl body portion 232 is engaged with a roller 233, and a counterbalance spring 234 is connected between the pawl body portion 232 and the mounting portion 267.

The braking device 25 is fixed within the mounting space S of the casing 10 and is configured to engage with the braking assembly 23. The braking device 25 includes a socket 251, a locking ring 252, a ratchet wheel 253, a brake pad 254, and a pad 255. The socket 251 is fitted onto the socket fixing portion 242 of the main shaft 24 for fixing. Since a peripheral surface of the socket fixing portion 242 is a non-circular surface, the socket 251 could not be rotated relative to the main shaft 24 once the socket 251 is fitted around the main shaft 24. A peripheral edge of an end of the socket 251 is connected to a mounting plate 2511. The locking ring 252 is detachably engaged with the socket 251. More specifically, the locking ring 252 is fitted around the socket 251 and is fixed to the socket 251 by screwing.

The ratchet wheel 253 is rotatably fitted around the socket 251 and is positioned between the mounting plate 2511 and the locking ring 252. A periphery of the ratchet wheel 253 has a plurality of ratchet teeth 2531, and the ratchet wheel 253 is located on an inner side of the pawls 23A, so that the ratchet teeth 2531 are configured to mesh with the pawl nose portion 231 of each of the pawls 23A. In this way, the braking device 25 is configured to engage with the braking assembly 23. When the fall arrest device 100 for recovering the rope at the reduced speed is in an idle state, the rollers 233 of the pawls 23A abut against the periphery of the ratchet wheel 253. The brake pad 254 is compressed and is sandwiched between the mounting plate 2511 and the ratchet wheel 253, while the pad 255 is compressed and sandwiched between the ratchet wheel 253 and the locking ring 252. In this way, the brake pad 254 generates a braking effect by providing a frictional resistance to the ratchet wheel 253 as the ratchet wheel 253 rotates relative to the socket 251.

When the rope 21 is pulled outward from the rope exit 18 by an external force and the rotating drum 26 is driven to rotate around the main shaft 24, the rollers 233 of the pawls 23A in the braking assembly 23 will roll or slide along the periphery of the ratchet wheel 253. As the rotating drum 26 rotates slowly, each of the rollers 233 could remain in a state of sliding or rolling along a surface of the ratchet teeth 2531. However, when a rotation speed of the pawls 23A of the braking assembly 23 exceeds a predetermined rotation speed as rotating with the rotating drum 26, a collision between each of the rollers 233 and the ratchet teeth 2531 causes the pawls 23A to rotate, so that the pawl nose portion 231 of each of the pawls 23A meshes with one of the ratchet teeth 2531.

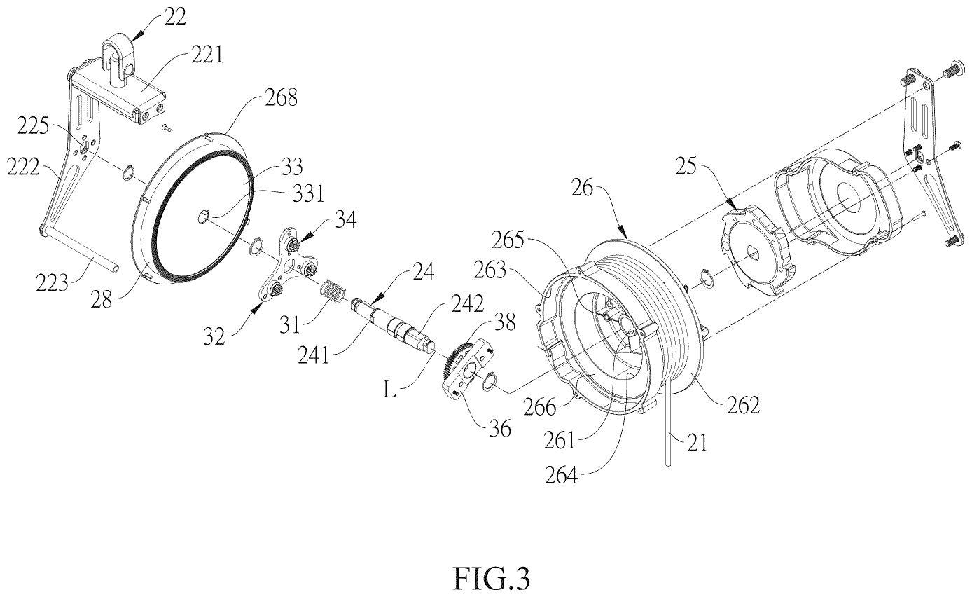

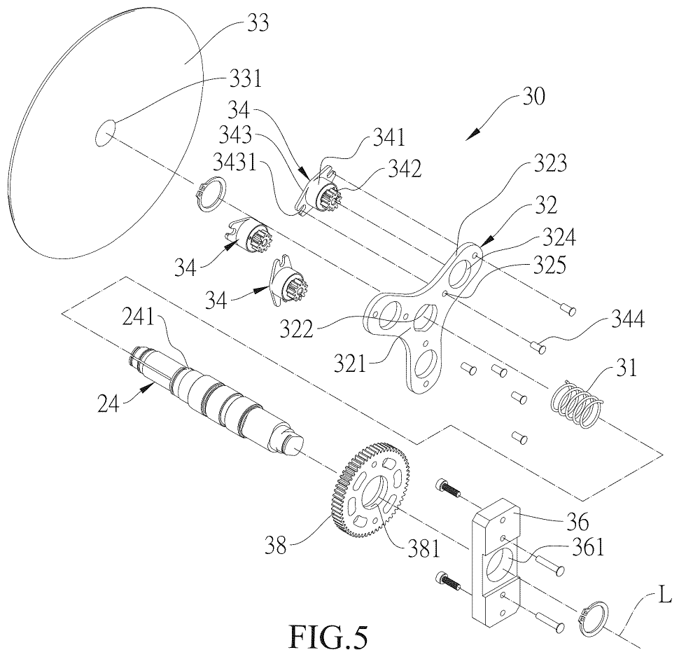

Referring to FIG. 3, FIG. 5, FIG. 7, and FIG. 10, the deceleration assembly 30 is disposed in the deceleration assembly cavity 264 of the rotating drum 26 and includes a damper holder 32, three rotary dampers 34, a driving gear seat 36, a driving gear 38 and a compression spring 31. The damper holder 32 is fixed to the main shaft 24. More specifically, the damper holder 32 has a base 321, and a center of the base 321 has a base hole 322. The base hole 322 is a non-circular hole that is fitted onto the holder fixing portion 241 of the main shaft 24 for fixing. A periphery of the base 321 is connected to three extension arms 323, each of which has a through hole 324. The through holes 324 are equidistant from the main shaft 24, and a portion of each of the extension arm 323 corresponding to two sides of the corresponding through hole 324 has a pair of perforations 325.

The rotary dampers 34 are each fixed to the extension arms 323, so that the rotary dampers 34 are spaced apart from the main shaft 24. Each of the rotary dampers 34 has a body 341 and the body 341 of each of the rotary dampers 34 passes through the through hole 324 of each of the extension arms 323. A side of the body 341 of each of the rotary dampers 34 near the inner wall portion 265 has a reduction gear 342, which is coaxial with the body 341. A diameter of the reduction gear 342 is smaller than a diameter of the body 341. Another side of the body 341 of each of the rotary dampers 34 away from the inner wall portion 265 has a bottom plate 343. The bottom plate 343 of each of the rotary dampers 34 abuts against a surface of each of the extension arms 323 and has a pair of bottom plate perforations 3431 on two sides of the bottom plate 343. Three pairs of fixing members 344 are provided and each of the pairs of fixing members 344 passes through the pair of perforations 325 of each of the extension arms 323 and the pair of bottom plate perforations 3431 of each of the bottom plates 343. In the current embodiment, the fixing members 344 are rivets that are riveted to a partition 33. The partition 33 is a circular plate and abuts against the flange portion 266. A center of the partition 33 has a partition perforation 331. The main shaft 24 passes through the partition perforation 331. The partition 33 separates the spiral spring cavity 263 from the deceleration assembly cavity 264.

The driving gear seat 36 is engaged with the inner wall portion 265 of the rotating drum 26 by screwing. A center of the driving gear seat 36 has a gear seat axial hole 361, which is rotatably fitted onto the main shaft 24. The driving gear 38 is engaged with the driving gear seat 36 by screwing, so that fixing the driving gear 38 is fixed to the inner wall portion 265 of the rotating drum 26 through the driving gear seat 36. A center of the driving gear 38 has a gear axial hole 381, which is rotatably fitted onto the main shaft 24 and is coaxial with the rotating drum 26. The driving gear 38 is meshed with the inner side of the reduction gears 342 of the rotary dampers 34.

In the current embodiment, the rotary dampers 34 are one-way rotary dampers and only provide resistance to slow down a reverse rotation speed of the rotating drum 26 only when the rotating drum 26 rotates reversely. The compression spring 31 is positioned around the main shaft 24 and has two ends. One end of the compression spring 31 abuts against the base 321 of the damper holder 32, while the other end of the compression spring 31 abuts against the driving gear 38. In this way, the driving gear 38 could maintain a distance from the bodies 341 of the rotary dampers 34, so that the driving gear 38 is prevented from getting too close to the bodies 341 during rotation, thereby avoiding friction between the driving gear 38 and the bodies 341, which could hinder a rotational movement of the driving gear 38.

A value of the predetermined rotation speed is set in correspondence with a practical scenario that the casing 10 of the present invention is hanged on a fixed place by the ring 224 and the other end of the rope 21 extending out of the rope exit 18 is engaged with a wearable harness of a user as shown in FIG. 7 and FIG. 10. The value of the predetermined rotation speed is typically set to be greater than a rotation speed of a rotation of the rotating drum 26 caused by pulling the rope 21 outwards from the rope exit 18 with hands or a movement of the user. The value of the predetermined rotation speed is set to be less than a rotation speed of a rotation of the rotating drum 26 caused by pulling the rope 21 outwards due to the user falling from height. In this way, the fall arrest device 100 for recovering the rope at the reduced speed of the present invention could prevent the user from continuously falling when the user falls from height; at a normal state, the rope 21 could be pulled outwards by the hands or the movement of the user, so that the movement of the user during working would not be obstructed.

The deceleration assembly 30 is disposed between the rotating drum 26 and the main shaft 24, so that when a user pulls the rope 21 out of the casing 10 to a certain length, a damping effect of the rotary dampers 34 could counteract the restoring force of the spiral spring 28 that drives the rotating drum 26 to rotate reversely and rewind the rope 21. Thus, when the user pulls the rope 21 out of the casing 10 to a certain length, and an engagement between the rope 21 and the wearable harness is suddenly loosened or the rope 21 is suddenly released, the damping effect of the rotary dampers 34 could slow down a speed at which the spiral spring 28 drives the rotating drum 26 to rotate reversely and recover the rope 21. In this way, the speed of recovering the rope 21 could be prevented from being too high, which could pose a danger as the rope 21 swings and collides with the user or objects.

In the current embodiment, the braking assembly 23 includes two pawls 23A. In other embodiments, the braking assembly 23 may also include three or more pawls 23A, wherein the pawls 23A are arranged around the main shaft 24. Furthermore, in the current embodiment, the braking device 25 is equipped with the brake pad 254 positioned between the mounting plate 2511 and the ratchet wheel 253, and the pad 255 placed between the locking ring 252 and the ratchet wheel 253. Additionally, a braking effect on the rotation of the ratchet wheel 253 could be generated by directly clamping and sandwiching the ratchet wheel 253 between the mounting plate 2511 and the locking ring 252.

In the current embodiment, the damper holder 32 of the deceleration assembly 30 is engaged with three rotary dampers 34. In other embodiments, the damper holder 32 could also be engaged with one, two, or other numbers of the rotary dampers 34. In the current embodiment, the driving gear 38 is engaged with the inner wall portion 265 of the rotating drum 26 through the driving gear seat 36. In other embodiments, the driving gear seat 36 could be omitted from the inner wall portion 265 and the driving gear 38 could be directly fixed to the inner wall portion 265 of the rotating drum 26 in a coaxial manner, which could also achieve the effect that the rotating drum 26 is engaged with to the deceleration assembly 30 and the rotating drum 26 could be decelerated by deceleration assembly 30 as the rotating drum 26 is driven by the spiral spring 28 to rotate reversely.

It must be pointed out that the embodiments described above are only some preferred embodiments of the present invention. All equivalent structures which employ the concepts disclosed in this specification and the appended claims should fall within the scope of the present invention.

What is claimed is:

1. A fall arrest device for recovering a rope at a reduced speed, comprising:
a casing, wherein a mounting space is provided in the casing, and a side of the casing has a rope exit; the rope exit communicates with the mounting space;
a main body, comprising a main shaft, a rotating drum, a spiral spring, a rope, a braking assembly, and a braking device, wherein the main shaft is fixed in the mounting space; the rotating drum is rotatably fitted around the main shaft; a side of the rotating drum has a mounting portion; a spiral spring cavity and a deceleration assembly cavity are provided in the rotating drum; a portion of an inner side of the rotating drum that is adjacent to the deceleration assembly cavity forms an inner wall portion; the spiral spring is disposed in the spiral spring cavity and has two ends; the two ends of the spiral spring are engaged with the main shaft and the rotating drum, respectively; an end of the rope is engaged with the rotating drum and is wound around the rotating drum to have a plurality of turns; another end of the rope extends out of the rope exit; the braking assembly is engaged with the mounting portion; the braking device is fixed in the mounting space and is configured to engage with the braking assembly; and
a deceleration assembly, disposed in the deceleration assembly cavity and comprising a damper holder, at least one rotary damper, and a driving gear, wherein the damper holder is fixed to the main shaft; the at least one rotary damper is fixed to the damper holder and is spaced apart from the main shaft; the driving gear is fixed to the inner wall portion of the rotating drum and is coaxial with the rotating drum; the driving gear is meshed with the at least one rotary damper.

2. The fall arrest device as claimed in claim 1, wherein the main shaft has a holder fixing portion, and a peripheral surface of the holder fixing portion is a non-circular surface; the damper holder has a base, and a center of the base has a base hole, which is a non-circular hole and is fitted onto the holder fixing portion for fixing; a periphery of the base is connected to a plurality of extension arms; the at least one rotary damper includes a plurality of rotary dampers, each of the plurality of rotary dampers is fixed to each of the plurality of extension arms and has a body; a side of the body near the inner wall portion has a reduction gear, which is coaxial with the body; a diameter of the reduction gear is smaller than a diameter of the body; the driving gear is meshed with the plurality of reduction gears of the plurality of rotary dampers.

3. The fall arrest device as claimed in claim 2, wherein the deceleration assembly further includes a compression spring, which is disposed around the main shaft and has two ends; the two ends of the compression spring abut against the base of the damper holder and the driving gear, respectively.

4. The fall arrest device as claimed in claim 2, wherein each of the plurality of extension arms has a through hole; the plurality of through holes of the plurality of extension arms are equidistant from the main shaft; a portion of each of the plurality of extension arms corresponding to two sides of the through hole has a pair of perforations; the body of each of the plurality of rotary dampers passes through the through hole of each of the plurality of extension arms; another side of the body away from the inner wall portion has a bottom plate; the bottom plate of each of the plurality of rotary dampers abuts against a surface of each of the plurality of extension arms and has a pair of bottom plate perforations on two sides of the bottom plate; a plurality of pairs of fixing members are provided; each of the plurality of pairs of fixing members passes through the pair of perforations of each of the plurality of extension arms and the pair of bottom plate perforations of each of the plurality of rotary dampers.

5. The fall arrest device as claimed in claim 4, wherein the spiral spring cavity communicates with the deceleration assembly cavity, and a diameter of the spiral spring cavity is greater than a diameter of the deceleration assembly cavity; a flange portion is formed around a perimeter between the spiral spring cavity and the deceleration assembly cavity; the plurality of pairs of fixing members are rivets that are riveted to a partition; the partition abuts against the flange portion and has a partition perforation on a the center of the partition; the main shaft passes through the partition perforation.

6. The fall arrest device as claimed in claim 5, wherein a center of the rotating drum has an axial hole, which communicates with the deceleration assembly cavity and is rotatably fitted onto the main shaft; the deceleration assembly further includes a driving gear seat, which is engaged with the inner wall portion of the rotating drum; the driving gear is fixed to the inner wall portion of the rotating drum through the driving gear seat.

7. The fall arrest device as claimed in claim 6, wherein the driving gear seat is engaged with the inner wall portion by screwing; a center of the driving gear seat has a gear seat axial hole, which is rotatably fitted onto the main shaft; the driving gear is engaged with the driving gear seat by screwing; a center of the driving gear has a gear axial hole, which is rotatably fitted onto the main shaft.

8. The fall arrest device as claimed in claim 2, wherein the braking assembly includes at least two pawls, which are arranged around the main shaft; a center of each of the at least two pawls is rotatably connected around the mounting portion; an end of each the at least two pawls forms a pawl nose portion, while another end of each of the at least two pawls forms a pawl body portion; the pawl body portion is engaged with a roller, and a counterbalance spring is connected between the pawl body portion and the mounting portion; a plurality of ratchet teeth are provided around the braking device, and the plurality of ratchet teeth are located on an inner side of the at least two pawls and are configured to mesh with the pawl nose portion of each of the at least two pawls; when the braking assembly rotates with the rotating drum, the at least two rollers of the at least two pawls roll or slide along the plurality of ratchet teeth around the braking device; when a rotation speed of the braking assembly rotating with the rotating drum exceeds a predetermined rotation speed, the at least two rollers of the at least two pawls collide with the plurality of ratchet teeth, so that each of the at least two pawls rotates and the pawl nose portion of each of the at least two pawls is meshed with one of the plurality of ratchet teeth.

9. The fall arrest device as claimed in claim 8, wherein the main shaft has a socket fixing portion, and a peripheral surface of the socket fixing portion is a non-circular surface; the braking device includes a socket, a locking ring, and a ratchet wheel; the socket is fitted onto the socket fixing portion of the main shaft for fixing; a peripheral edge of an end of the socket is connected to a mounting plate; the locking ring is detachably engaged with the socket; the ratchet wheel is rotatably fitted onto the socket and is sandwiched between the mounting plate and the locking ring; the plurality of ratchet teeth are formed on a periphery of the ratchet wheel.

10. The fall arrest device as claimed in claim 9, wherein another side of the casing has a ring hole, which communicates with the mounting space; the main body includes a frame, which is fitted into the mounting space and includes a ring seat, two side plates, and a connecting rod; the ring seat is engaged with a ring, which passes through the ring hole; two ends of the two side plates are respectively connected to two sides of the ring seat, while another two ends of the side plates are respectively connected to two ends of the connecting rod; a center of each of the two side plates has a side plate perforation, which is a non-circular perforation; two ends of the main shaft are fitted into the two side plate perforations of the two side plates for fixing.
